(19) United States
(12) Patent Application Publication
(10) Pub. No.: US 2024/0225360 A1
(43) Pub. Date: Jul. 11, 2024

(54) COFFEE GRINDER SYSTEM

(71) Applicant: Eduard BIERNATEK, Rodgau (DE)

(72) Inventor: Eduard BIERNATEK, Rodgau (DE)

(21) Appl. No.: 18/531,791

(22) Filed: Dec. 7, 2023

(30) Foreign Application Priority Data
Dec. 9, 2022 (LU) 503169

(51) Int. Cl. A47J 42/46; A47J 42/34; A47J 42/36

(52) U.S. Cl. CPC A47J 42/46; A47J 42/34; A47J 42/36

(57) ABSTRACT

The invention relates to a coffee grinder system comprising a coffee grinder, which contains a housing and a grinding mechanism arranged in the housing, and comprising a drive device for driving the grinding mechanism. The coffee grinder system is distinguished in that the coffee grinder is or can be movably and/or self-centeringly coupled to the drive device.

### CROSS-REFERENCE TO RELATED APPLICATION

The present application claims priority to and benefit of Luxembourgian Patent Application No. 503169 filed Dec. 9, 2022, the entire disclosure of which is incorporated herein by reference.

### FIELD

The disclosure relates to a coffee grinder system comprising a coffee grinder, which contains a housing and a grinding mechanism arranged in the housing, and comprising a drive device for driving the grinding mechanism.

### BACKGROUND

Coffee grinder systems of the type mentioned in the introduction are usually structured such that the housing contains the drive device in the form of an electric drive motor. Here, at the factory the drive device is installed fixedly in the housing and precisely adjusted relative to the grinding mechanism likewise installed fixedly in the housing, this adjustment being complex. In the case of an adjustment which is not completely correct, a shortened service life, malfunctions, such as sudden jamming, and/or damage occur(s). Since it is usually not intended, and usually is also not possible, for such coffee grinder systems to be easily taken apart into components for maintenance and repair purposes, repair when the aforementioned problems arise is generally not worthwhile.

### SUMMARY

The object of the present disclosure is therefore to specify a coffee grinder system which enables reliable driving of the grinding mechanism and has a simple structure.

The object is achieved by a coffee grinder system of the type mentioned in the introduction, which is distinguished in that the coffee grinder is or can be movably and/or self-centeringly coupled to the drive device.

The coffee grinder system according to the disclosure has the very considerable advantage that forces that might cause increased wear of components of the coffee grinder system and/or jamming of the connection between the drive device and the coffee grinder cannot be effective, in particular because the movable attachment allows the relevant components to be displaced relative to one another, and/or that such forces do not arise at all by virtue of the self-centering.

The drive device may advantageously have an electric drive motor. Moreover, the drive device may have at least one transmission connected downstream of the electric drive motor in terms of drive. The drive motor and the transmission may in particular be arranged coaxially with one another.

In an alternative embodiment, the drive device has a manually actuatable operating element, such as a crank or an actuating lever mounted so as to be pivotable back and forth, it being possible to connect at least one transmission downstream of the manually actuatable operating element in terms of drive.

In a particular embodiment, the coffee grinder has a rotatably mounted drive element for introducing a torque into the grinding mechanism. Furthermore, it may advantageously be provided that the drive device has an output element, which is mounted in particular rotatably and/or is driven in rotation about an output axis of rotation and is or can be torque-transmittingly connected to the drive element. Connecting the drive element of the coffee grinder to the output element of the drive device establishes a torque-transmitting connection in order to be able to drive the grinding mechanism in rotation for a grinding operation.

In a particular embodiment, the drive element, in particular the drive shaft of the drive element, is connected to a grinding rotor, in particular a grinding cone, for conjoint rotation. In such an embodiment, a grinding stator of the grinding mechanism, for example a grinding ring, can be arranged rotationally fixedly relative to the housing.

In a very particularly advantageous embodiment, the coffee grinder coupled to the drive device is movable in a plane perpendicular to the drive axis of rotation and/or in a plane perpendicular to the output axis of rotation. In particular, the coffee grinder coupled to the drive device may be linearly movable in a direction perpendicular to the drive axis of rotation and/or in a direction perpendicular to the drive axis of rotation. As an alternative or in addition, it may advantageously be provided that the coffee grinder coupled to the drive device is immovable in the direction of the drive axis of rotation. In such an embodiment, increased wear of components of the coffee grinder system and/or jamming of the connection between the drive device and the coffee grinder is effectively avoided.

In a particular embodiment, the coupling device, by means of which the housing of the coffee grinder can be coupled to the drive device, is designed such that it permits a movement of the coffee grinder coupled to the drive device in a plane perpendicular to the drive axis of rotation and/or in a plane perpendicular to the output axis of rotation. In particular, the coupling device may be designed such that it permits a linear movement of the coffee grinder coupled to the drive device in a direction perpendicular to the drive axis of rotation and/or in a direction perpendicular to the output axis of rotation.

As an alternative or in addition, the coupling device, by means of which the housing of the coffee grinder can be coupled to the drive device, may be designed such that it does not permit any movement of the coffee grinder coupled to the drive device in the direction of the drive axis of rotation and/or in the direction of the output axis of rotation. It has been found that increased wear of components of the coffee grinder system and/or jamming of the connection between the drive device and the coffee grinder can also be avoided when it is not possible for the coffee grinder coupled to the drive device to move in the direction of the drive axis of rotation and/or in the direction of the output axis of rotation. However, the provision of such movability is not ruled out in principle.

In a very particularly advantageous embodiment, the coffee grinder coupled to the drive device (alternatively or additionally to the possible movement capabilities described above) is pivotable about a pivot axis which is not parallel to and not coaxial with the drive axis of rotation and/or about a pivot axis which is not parallel to and not coaxial with the output axis of rotation. In particular, the coffee grinder coupled to the drive device may be pivotable about a pivot axis perpendicular to the drive axis of rotation and/or about a pivot axis perpendicular to the output axis of rotation.

In a particular embodiment, the coupling device, by means of which the housing of the coffee grinder can be coupled to the drive device, is designed such that it permits a pivoting movement of the coffee grinder coupled to the drive device about a pivot axis which is not parallel to and not coaxial with the drive axis of rotation and/or about a pivot axis which is not parallel to and not coaxial with the output axis of rotation. In particular, the coupling device may be designed such that it permits a pivoting movement of the coffee grinder coupled to the drive device about a pivot axis perpendicular to the drive axis of rotation and/or about a pivot axis perpendicular to the output axis of rotation. In particular, it is possible

In a very particularly advantageous embodiment, the coffee grinder coupled to the drive device (alternatively or additionally to the possible movement capabilities and/or pivoting capabilities described above) is or can be coupled to the drive device self-centeringly with respect to a direction which differs from the direction of the drive axis of rotation and/or with respect to a direction which differs from the direction of the output axis of rotation. In particular, it may advantageously be provided that the coffee grinder is or can be coupled to the drive device self-centeringly with respect to a direction which is perpendicular to the direction of the drive axis of rotation and/or with respect to a direction which is perpendicular to the direction of the output axis of rotation.

In a particular embodiment, the coupling device, by means of which the housing of the coffee grinder can be coupled to the drive device, is designed such that it permits self-centering of the coffee grinder coupled to the drive device with respect to a direction which differs from the direction of the drive axis of rotation and/or with respect to a direction which differs from the direction of the output axis of rotation. In particular, the coupling device may be designed such that it permits self-centering of the coffee grinder coupled to the drive device with respect to a direction perpendicular to the drive axis of rotation and/or with respect to a direction perpendicular to the output axis of rotation.

In a very particularly advantageous embodiment, the torque-transmitting connection is designed such that it can be established without tools by the user. As an alternative or in addition, it can advantageously be provided that the torque-transmitting connection can be redetached without tools. These embodiments have the very particular advantage that the coffee grinder system can be easily taken apart and reassembled by the user, for example for cleaning or maintenance purposes. Furthermore, these embodiments have the very particular advantage that the drive device can be easily decoupled, in order to be able to couple another, in particular a different, drive device or a hand crank instead.

An embodiment in which the torque-transmitting connection is in the form of a compensating coupling or comprises a compensating coupling is very particularly robust and insusceptible to damage. The compensating coupling may for example be configured such that an offset, in particular an axial offset, of the drive element and of the output element, in particular of a drive shaft of the drive element and of an output shaft of the output element, is compensated. To this end, the compensating coupling may for example be designed according to the principle of an Oldham coupling. It is alternatively or additionally also possible that the compensating coupling is designed to compensate an angular error of the drive element relative to the output element, in particular an angular error of a drive shaft of the drive element relative to an output shaft of the output element. To this end, the compensating coupling may for example be designed according to the principle of a cardan joint. The compensating coupling may be formed by the drive element and the output element. It is also possible that the compensating coupling contains the drive element and/or the output element.

In a particularly advantageous embodiment, the torque-transmitting connection is designed such that it permits a movement of the drive element relative to the output element, in particular a tilting movement and/or a radial movement, during a driving operation. Such an embodiment, as already mentioned, has the very particular advantage that any forces arising, in particular owing to an offset or angular error, cannot have a damaging effect.

For example, the drive element may have a driver bar arranged transversely to a drive shaft. In particular, the driver bar may be arranged perpendicularly in relation to the axis of rotation of the drive shaft. The function of the driver bar is to interact with at least one component of the output element, in order to transmit a torque. To this end, the output element may for example comprise a fork having tines, which in particular are aligned in the direction of the axis of rotation of the drive element and/or in the direction of the axis of rotation of the output element. In this respect, the tines may rest directly against the driver bar in order to transmit a torque from the output element to the drive element. Such a design of the coffee grinder system has the very particular advantage that the coffee grinder automatically self-centers relative to the drive device during the driving operation, in particular when the housing is held movably on the drive device, in particular on a stand of the drive device.

The driver bar may for example extend through a through-bore in the drive shaft. In this respect, at least one fastening element, in particular a clamping screw, by means of which the driver bar can be fixed relative to the drive shaft may advantageously be present.

In an advantageous embodiment, the housing is or can be movably coupled to the drive device by means of a coupling device.

In a very particularly advantageous embodiment, the drive element and the output element are designed and arranged such that the torque-transmitting connection is automatically established when the housing is fastened to the drive device by means of the coupling device. For example, it may advantageously be provided that the coupling device has a first coupling element of the drive device and a second coupling element arranged on the housing, with the coupling elements, the drive element and the output element being designed and positioned such that the drive element and the output element are operatively connected to one another automatically and preferably unavoidably when an operative connection of the first coupling element to the second coupling element is established. Such an embodiment has the very particular advantage that the user can couple the coffee grinder to the drive device very easily without it being necessary to produce multiple coupling connections, this production being complex.

The coupling device is preferably designed and arranged to support a torque introduced into the grinding mechanism by the drive element. In other words, in such an embodiment the coupling device prevents the housing from conjointly rotating when a torque is introduced into the drive element by the output element. In this respect, however, it is not advantageous to prevent any possible movement of the housing and its contents. Rather, as already explained in detail, it may be provided that the coupling device is designed such that movements of the housing, in particular such movements that are necessary for a centering operation, in particular a self-centering operation, are possible. This can be achieved, for example, in that the coupling device is designed to permit a pivoting movement, in particular a pivoting movement about an axis perpendicular to the axis of rotation of the drive shaft, and/or a linear movement, in particular a linear movement in a plane perpendicular to the axis of rotation of the drive shaft, during a driving operation. Embodiments in which the coupling device alternatively or additionally permits other movements are possible in principle.

The coupling device may for example have two coupling elements, one of which is part of the drive device and the other of which is arranged on the housing and which can be operatively connected to one another in order to couple the housing rotationally fixedly to the drive device. As explained in more detail below, one of the coupling elements may be in the form for example of a plug-in peg, while the other one of the coupling elements is in the form of a plug-in peg receptacle.

In particular, the coupling element arranged on the housing is arranged in such a way that it can act as torque support when the coffee grinder is driven by a hand crank instead of by the drive device. In particular, the coupling element arranged on the housing may be positioned such that it rests against the thumb, in particular the tip of the thumb, of the user's hand that wholly or partially grasps the preferably circular-cylindrical housing, In this way, by means of their thumb, the user can easily, in particular form-fittingly, support the torque that acts on the housing when the hand crank is actuated, it being possible for them to grip the housing relatively loosely. In this case, the coupling element arranged on the housing preferably acts as a stop element and the thumb as counter-stop element. This has the very particular advantage that the user does not need, or needs at least only to a small extent, to support the torque by grasping the housing particularly tightly, in order to establish a frictional connection between their hand and the housing that is sufficient to support the torque. Instead of the design described above of the coupling element arranged on the housing in the form of a “thumb stopper”, it is alternatively also possible to arrange the coupling element such that it interacts with one or more other fingers of the hand that grips the housing instead of with the thumb.

In a very particularly advantageous embodiment, the coupling device has a plug-in peg, which is arranged on the housing and can be plugged into a plug-in peg receptacle of the drive device along a plug-in direction. As an alternative, it may also be provided that the drive device has a plug-in peg, which can be plugged into a plug-in peg receptacle arranged on the housing along a plug-in direction. These embodiments permit the housing to be very particularly easily coupled to the drive device by inserting the plug-in peg into the plug-in peg receptacle.

The coupling element arranged on the housing may in particular be produced in one piece with the housing. It is alternatively also possible for the coupling element arranged on the housing to be connected fixedly to the housing by means of an integral bond. As an alternative, it is also possible for the coupling element to be fastened to the housing by a form fit and/or frictional engagement, for example by at least one screwed connection.

In a very particularly advantageous embodiment, the coupling element is fastened to the housing by means of at least one clip, which engages around the housing.

In particular, a fastening device for fastening the coupling element to the housing may advantageously be present. The fastening device may in particular be designed such that the coupling element can be fastened to the housing without damaging the housing. In particular, the fastening device may advantageously be designed such that it is possible to retrofit existing coffee grinders that do not have a coupling device for coupling to a drive device. In particular, to this end the fastening device may advantageously have at least one clip which engages around the housing.

In particular, such a coupling device may be designed in such a way that the housing in the coupled state is pivotable relative to the drive device about the center axis of the plug-in peg extending in the plug-in direction and/or that the housing in the coupled state is displaceable relative to the drive device along a center axis of the plug-in peg extending in the plug-in direction. Such an embodiment is an example of how to design the coupling device to enable movements of the housing, in particular such movements that are necessary for a centering operation, in particular a self-centering operation.

In an embodiment that can be used very particularly flexibly, the coffee grinder system has a hand crank. In this embodiment, the coffee grinder is designed to be selectively coupled to the drive device or to the hand crank. In this respect, the user has the choice either of operating the coffee grinder with the hand crank or coupling the coffee grinder to the preferably electric drive device. For example, the user has the option of taking the coffee grinder on journeys and using it together with the hand crank, whereas at home they use the coffee grinder in combination with the drive device.

An embodiment in which the coffee grinder can be coupled to the hand crank without tools and/or coupled to the hand crank redetachably without tools is very particularly advantageous. For this, it is advantageously possible to provide in particular plug-in and clamping connections. For example, it may advantageously be provided that the hand crank is designed to be inserted into the through-bore in the drive shaft instead of the driver bar. In particular, for this it may be provided that the hand crank, at least in the end region, has the same cross section, in particular the same diameter, as the driver bar. Moreover, it may advantageously be provided that the hand crank can be fixed relative to the drive shaft by means of an in particular axially screwed-in clamping screw.

An embodiment in which the housing is designed to be held in a user's hand during a grinding operation, the user being able to actuate the hand crank with their other hand, is of very particular advantage.

The housing may advantageously be tubular. Such an embodiment has the particular advantage that it is particularly compact and stable. In this respect, a filling opening may be formed, for example by an upper tube opening. The housing may be at least partially cylindrical, in particular circular-cylindrical. In particular, it may advantageously be provided that the housing has a circular outer contour and/or a circular inner contour in a cross-sectional plane perpendicular to its direction of longitudinal extent.

The housing may contain a drive shaft which extends in the direction of longitudinal extent of the in particular tubular housing. In particular, the housing may have at least one bearing block, by means of which at least one grinder element, in particular the drive element or at least the drive shaft of the drive element or a component of the grinding mechanism, such as a grinding cone, is mounted rotatably relative to the housing.

The housing preferably has a filling opening for coffee beans that are to be ground and a dispensing opening for the coffee powder. The dispensing opening may for example be formed by a lower tube opening if the housing is tubular.

In a very particularly advantageous embodiment, the housing surrounds a receiving space for coffee beans that are to be ground. Such an embodiment has the very particular advantage that a store of coffee beans that are to be ground can be filled and, if required, also remain in the receiving space for a lengthy period of time. Furthermore, such an embodiment has the very particular advantage that substantially no additional components are necessary to form the receiving space.

### BRIEF DESCRIPTION OF THE DRAWING VIEWS

In the drawing, the subject matter of the disclosure is illustrated schematically and by way of example and will be described on the basis of the figures, with elements that are the same or have the same effect even in different exemplary embodiments are usually provided with the same reference signs. In the drawing:

FIG. 1 shows a perspective view of an exemplary embodiment of a coffee grinder system according to the disclosure,

FIG. 2 shows the drive device of the exemplary embodiment of a coffee grinder system according to the disclosure,

FIG. 3 shows the coffee grinder of the exemplary embodiment of a coffee grinder system according to the disclosure,

FIG. 4 shows the coffee grinder of the exemplary embodiment of a coffee grinder system according to the disclosure to which a hand crank is coupled, and

FIG. 5 shows a perspective view of a further exemplary embodiment of a coffee grinder system according to the disclosure.

### DETAILED DESCRIPTION

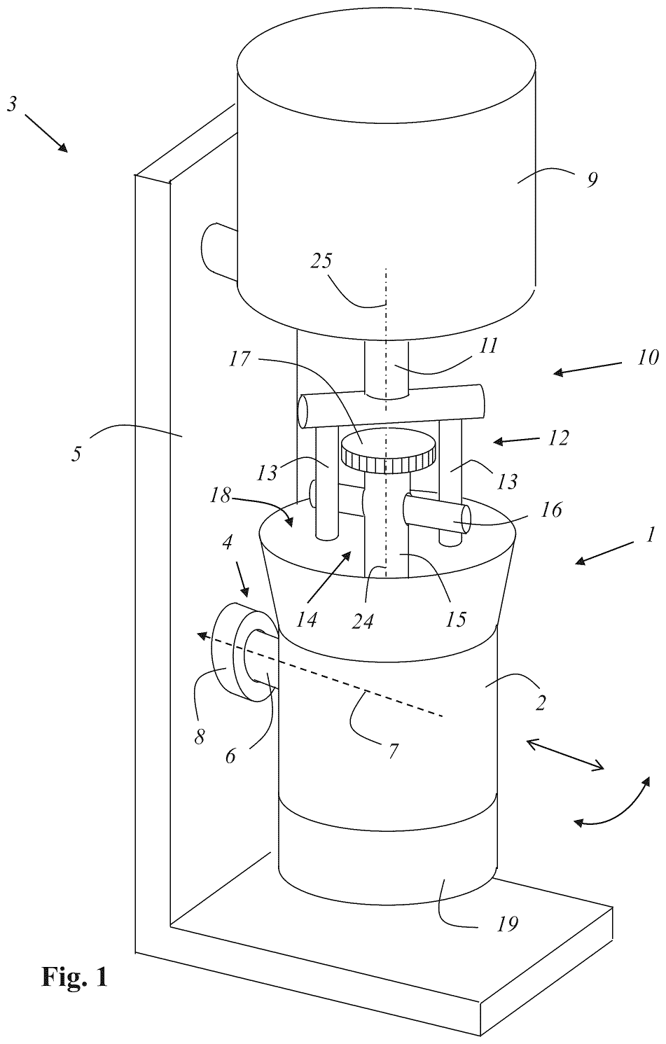

FIG. 1 shows a perspective view of an exemplary embodiment of a coffee grinder system according to the disclosure. The coffee grinder system comprises a coffee grinder 1, which contains a housing 2 and a grinding mechanism (not illustrated) arranged in the housing 2. The coffee grinder system moreover comprises a drive device 3 for driving the grinding mechanism. The coffee grinder 1 is movably and self-centeringly coupled to the drive device 3.

The housing 2 is movably coupled to a stand 5 of the drive device 3 by means of a coupling device 4. The coupling device 4 has two coupling elements, one of which is in the form for example of a plug-in peg 6, while the other one of the coupling elements is in the form of a plug-in peg receptacle 8. The coupling device 4 has a plug-in peg 6, which is arranged on the housing 2 and is plugged in a plug-in peg receptacle 8 of the drive device 3 along a plug-in direction 7. The coffee grinder system permits the housing 2 to be very particularly easily coupled to the drive device 3 by inserting the plug-in peg 6 into the plug-in peg receptacle 8. In the coupled state illustrated, the coffee grinder 1 is pivotable relative to the drive device 3 about the center axis of the plug-in peg 6 extending in the plug-in direction 7 and is held relative to the drive device 3 displaceably along the center axis of the plug-in peg 6 extending in the plug-in direction 7.

The drive device 3 has an electric drive unit 9 with an electric drive motor (not illustrated). The electric drive unit 9 is fixedly connected to the stand 5. The electric drive unit 9 may have at least one transmission connected downstream of the electric drive motor in terms of drive. Moreover, the electric drive unit 9 has an output element 10. The output element 10 contains an output shaft 11 and a fork 12, which is connected to the output shaft 11 for conjoint rotation and has tines 13 aligned in the direction of the output axis of rotation 25 of the output element 10.

The coffee grinder 1 has a drive element 14 which contains a drive shaft 15. The drive shaft 15 of the drive element 14 is connected to a grinding rotor (not illustrated) of the grinding mechanism (not illustrated) for conjoint rotation. The drive element 14 has a driver bar 16, which is arranged transversely to the drive shaft 15 and perpendicularly in relation to the drive axis of rotation 24 of the drive shaft 15. The driver bar 16 extends through a through-bore in the drive shaft 15 and is fixed relative to the drive shaft by means of an axially arranged clamping screw 17, which is screwed into an axial threaded bore in the end face of the drive shaft 15. The clamping screw 17 is arranged spatially between the tines 13.

The function of the driver bar 16 is to interact with the output element 10, in order to transmit a torque. To this end, the tines 13 rest directly against the driver bar 16 in order to transmit a torque from the output element 10 to the drive element 14.

The drive element 14 of the coffee grinder 1 and the output element 10 of the drive device 3 are designed and arranged such that the torque-transmitting connection between them is automatically established when the housing 2 is movably fastened to the drive device 3 by means of the coupling device 4.

The housing 2 is substantially tubular, with a filling opening 18 for the coffee beans that are to be ground being formed at the upper end. The housing 2 is coupled to a collecting container 19, which can be detached without tools and is intended for the coffee powder, at the lower end.

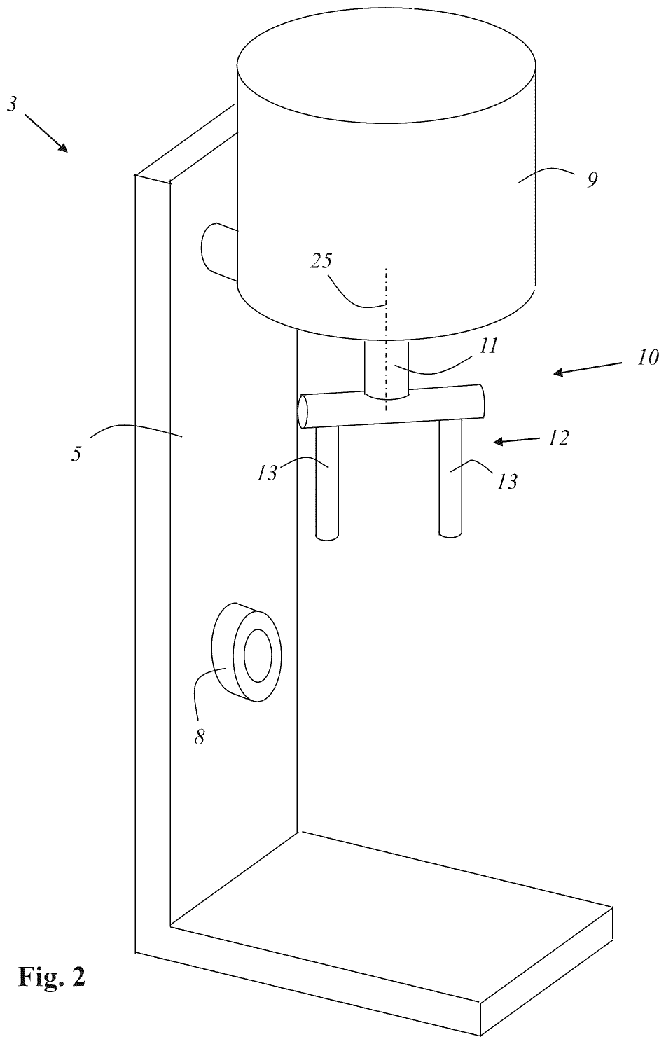

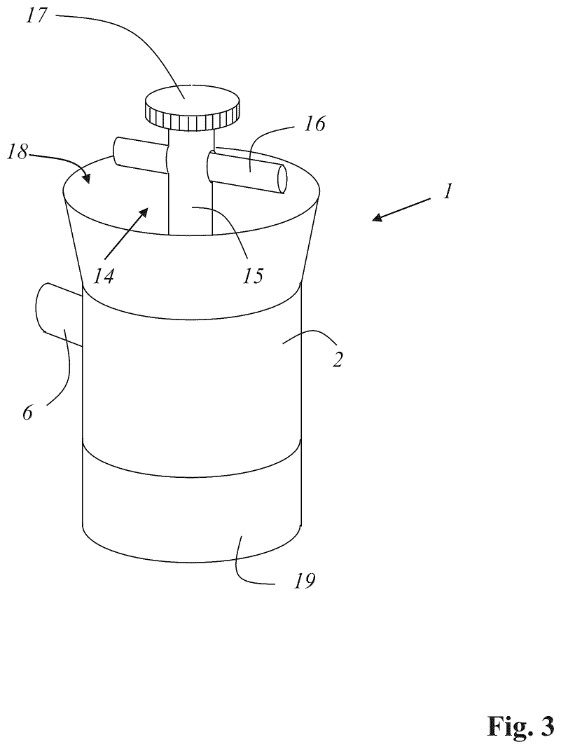

FIG. 2 shows the drive device 3 of the exemplary embodiment of a coffee grinder system according to the disclosure with the coffee grinder 1 removed, whereas FIG. 3 shows the removed coffee grinder 1.

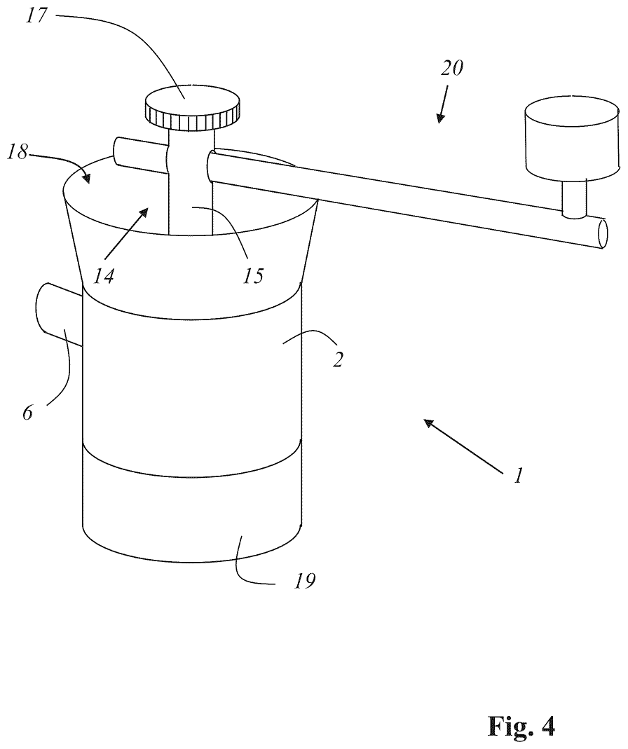

FIG. 4 shows the coffee grinder 1 of the exemplary embodiment, to which a hand crank 20 is coupled. To couple the hand crank 20, firstly the clamping screw 17 is detached, in order to be able to pull the driver bar 16 out of the through-bore in the drive shaft 15. Then, a coupling end of the hand crank 20 is plugged into the through-bore in the drive shaft 15 and fixed by means of the clamping screw 17. In the state illustrated, the coffee grinder 1 can be manually operated by means of the hand crank 20 instead of by the drive device 3 by the user holding the housing 2 in one hand and actuating the hand crank 20 with their other hand.

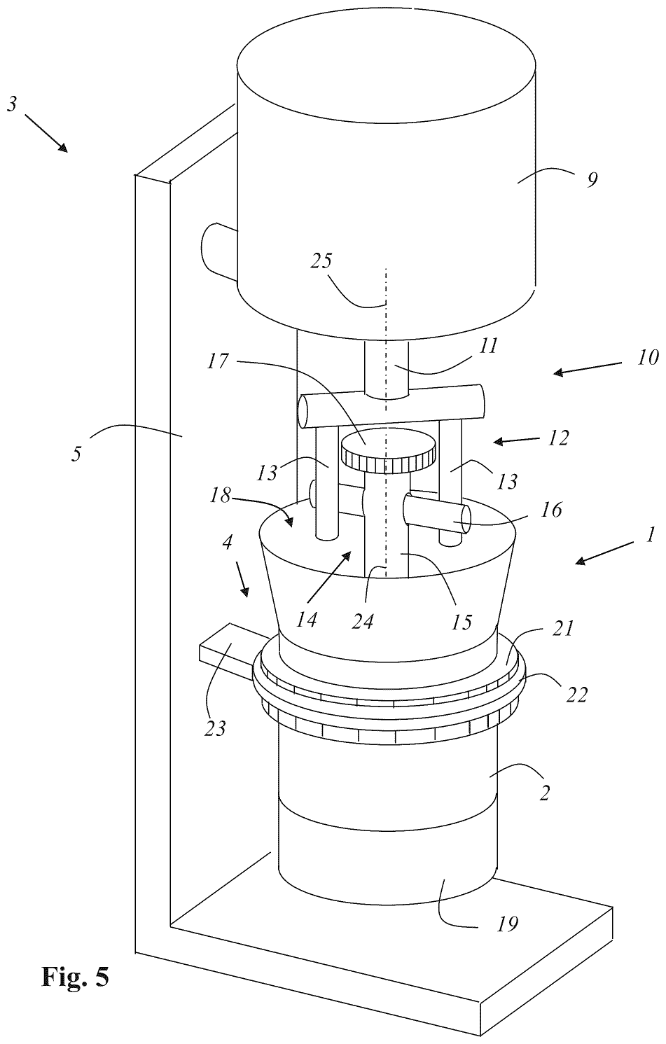

FIG. 5 shows a perspective view of a further exemplary embodiment of a coffee grinder system according to the disclosure. The coffee grinder system differs from the coffee grinder system illustrated in FIGS. 1 and 2 in that the coupling device 4 has a rigid holding ring 22, in which an elastomer ring 21, which may for example be a rubber ring, is fastened. The elastomer ring 21 surrounds the housing 2 of the coffee grinder 1. The holding ring 22 is fastened to the stand 5 by means of a bayonet connection 23. The bayonet connection 23 is preferably designed such that the coffee grinder 1 can be detached from the stand 5 without tools and fixed to the stator 5 without tools.

By virtue of the particular design of the coupling device 4 and in particular the elasticity of the elastomer ring 21 of the coupling device 4, the coffee grinder 1 is movably and/or self-centeringly coupled to the drive device. The coupling device 4 may be designed such that it is not possible for the coffee grinder 1 coupled to the drive device 3 to move in the direction of the drive axis of rotation 25 and/or in the direction of the output axis of rotation 24. For example, to this end, stops (not illustrated), which are supported against the holding ring 22 and thus prevent such a movement, may be present on the housing 2.

### LIST OF REFERENCE SIGNS

1 Coffee grinder
2 Housing
3 Drive device
4 Coupling device
5 Stand
6 Plug-in peg
7 Plug-in direction
8 Plug-in peg receptacle
9 Drive unit
10 Output element
11 Output shaft
12 Fork
13 Tines
14 Drive element
15 Drive shaft
16 Driver bar
17 Clamping screw
18 Filling opening
19 Collecting container
20 Hand crank
21 Elastomer ring
22 Holding ring
23 Bayonet connection
24 Drive axis of rotation
25 Output axis of rotation

What is claimed is:

1. A coffee grinder system comprising:
a coffee grinder (1) including a housing (2) and a grinding mechanism arranged in the housing (2), and
a drive device (3) for driving the grinding mechanism,
wherein the coffee grinder (1) is or can be movably and self-centeringly coupled to the drive device (3).

2. The coffee grinder system as claimed in claim 1, further comprising a coupling device (4), wherein the housing (2) is or can be movably coupled to the drive device (3) by the coupling device (4).

3. The coffee grinder system as claimed in claim 1, wherein the drive device (3) has an electric drive motor.

4. The coffee grinder system as claimed in claim 2, wherein the coffee grinder (1) has a drive element (14) for introducing a torque into the coffee grinder.

5. The coffee grinder system as claimed in claim 4, wherein the drive element (14) is mounted rotatably about a drive axis of rotation (24).

6. The coffee grinder system as claimed in claim 4, wherein the drive device (3) has an output element (10), which is or can be torque-transmittingly connected to the drive element (14).

7. The coffee grinder system as claimed in claim 6, wherein the output element (10) is mounted rotatably about an output axis of rotation (25) and/or is driven in rotation about an output axis of rotation (25).

8. The coffee grinder system as claimed in claim 5, wherein the drive device (3) has an output element (10), which is torque-transmittingly connected to the drive element (14) and the output element (10) is mounted rotatably about an output axis of rotation (25) and/or is driven in rotation about an output axis of rotation (25), wherein the coffee grinder system has at least one of the following features a to f:
a. the coffee grinder (1) coupled to the drive device (3) is movable in a plane perpendicular to the drive axis of rotation (24),
b. the coffee grinder (1) coupled to the drive device (3) is movable in a plane perpendicular to the output axis of rotation (25),
c. the coffee grinder (1) coupled to the drive device (3) is linearly movable in a direction perpendicular to the drive axis of rotation (24),
d. the coffee grinder (1) coupled to the drive device (3) is linearly movable in a direction perpendicular to the output axis of rotation (25),
e. the coffee grinder (1) coupled to the drive device (3) is immovable in the direction of the drive axis of rotation (24),
f. the coffee grinder (1) coupled to the drive device (3) is immovable in the direction of the output axis of rotation (25).

9. The coffee grinder system as claimed in claim 5, wherein the drive device (3) has an output element (10), which is torque-transmittingly connected to the drive element (14) and the output element (10) is mounted rotatably about an output axis of rotation (25) and/or is driven in rotation about an output axis of rotation (25), wherein the coffee grinder system has at least one of the following features a to d:
a. the coffee grinder (1) coupled to the drive device (3) is pivotable about a pivot axis which is not parallel to and not coaxial with the drive axis of rotation (24),
b. the coffee grinder (1) coupled to the drive device (3) is pivotable about a pivot axis which is not parallel to and not coaxial with the output axis of rotation (25),
c. the coffee grinder (1) coupled to the drive device (3) is pivotable about a pivot axis which is perpendicular to the drive axis of rotation (24),
d. the coffee grinder (1) coupled to the drive device (3) is pivotable about a pivot axis perpendicular to the output axis of rotation (25).

10. The coffee grinder system as claimed in claim 5, wherein the drive device (3) has an output element (10), which is torque-transmittingly connected to the drive element (14) and the output element (10) is mounted rotatably about an output axis of rotation (25) and/or is driven in rotation about an output axis of rotation (25), wherein the coffee grinder system has at least one of the following features a to d:
a. the coffee grinder (1) is or can be coupled to the drive device (3) self-centeringly with respect to a direction which differs from the direction of the drive axis of rotation (24),
b. the coffee grinder (1) is or can be coupled to the drive device (3) self-centeringly with respect to a direction which differs from the direction of the output axis of rotation (25),
c. the coffee grinder (1) is or can be coupled to the drive device (3) self-centeringly with respect to a direction which is perpendicular to the direction of the drive axis of rotation (24),
d. the coffee grinder (1) is or can be coupled to the drive device (3) self-centeringly with respect to a direction which is perpendicular to the direction of the output axis of rotation (25).

11. The coffee grinder system as claimed in claim 6, wherein the output element (10) is mounted rotatably about an output axis of rotation (25) and/or is driven in rotation about an output axis of rotation (25), wherein the coffee grinder system has at least one of the following features a to d:
a. the torque-transmitting connection can be established without tools and/or the torque-transmitting connection can be redetached without tools,
b. the torque-transmitting connection is in the form of a compensating coupling or comprises a compensating coupling,
c. the torque-transmitting connection permits a movement of the drive element (14) relative to the output element (10), in particular a tilting movement and/or a radial movement, during a driving operation,
d. the drive element (14) and the output element (10) are designed and arranged such that the torque-transmitting connection is automatically established when the housing (2) is fastened to the drive device (3) by means of the coupling device (4).

12. The coffee grinder system as claimed in claim 6, wherein
a. the drive element (14) has a driver bar (16) arranged transversely to a drive shaft and wherein the output element (10) comprises a fork having tines (13) aligned in particular in the axial direction, and/or wherein
b. the drive element (14) has a driver bar (16) which is arranged transversely to a drive shaft and extends through a through-bore in the drive shaft and wherein the output element (10) comprises a fork having tines (13) aligned in particular in the axial direction, and/or wherein
c. the drive element (14) has a driver bar (16) arranged transversely to a drive shaft and wherein the output element (10) comprises a fork having tines (13) aligned in particular in the axial direction, the driver bar (16) being fastened and/or fixed to or in the drive element.

13. The coffee grinder system as claimed in claim 4, wherein the coffee grinder system has at least one of the following features a to f:
a. the coupling device (4) supports a torque introduced into the grinding mechanism by the drive element (14),
b. the coupling device (4) permits a pivoting movement and/or a linear movement of the housing (2) during a driving operation,
c. the coupling device (4) has two coupling elements, one of which is part of the drive device and the other of which is arranged on the housing (2),
d. the coupling element arranged on the housing (2) is arranged in such a way that it can act as torque support when the coffee grinder (1) is driven by a hand crank (20) instead of by the drive device (3),
e. the coupling element arranged on the housing (2) is positioned relative to the housing (2) such that it rests against the thumb, in particular the tip of the thumb, of the user's hand that wholly or partially grasps the preferably circular-cylindrical housing (2),
f. the coupling element arranged on the housing (2) is fastened to the housing (2) by means of at least one clip.

14. The coffee grinder system as claimed in claim 2, wherein
a. the coupling device (4) has a plug-in peg (6), which is arranged on the housing (2) and can be plugged into a plug-in peg receptacle (8) of the drive device (3) along a plug-in direction (7), or wherein
b. the drive device (3) has a plug-in peg (6), which can be plugged into a plug-in peg receptacle (8) arranged on the housing (2) along a plug-in direction (7).

15. The coffee grinder system as claimed in claim 14, wherein
a. the housing (2) when coupled to the drive device (3) is pivotable relative to the drive device (3) about the center axis of the plug-in peg (6) extending in the plug-in direction (7), and/or wherein
b. the housing (2) when coupled to the drive device (3) is displaceable relative to the drive device (3) along the center axis of the plug-in peg (6) extending in the plug-in direction (7).

16. The coffee grinder system as claimed in claim 1, wherein the coffee grinder system has a hand crank (20) and wherein the coffee grinder (1) is designed to be selectively coupled either to the drive device (3) or to the hand crank (20).

17. The coffee grinder system as claimed in claim 16, wherein the coffee grinder system has at least one of the following features a to c:
a. the coffee grinder (1) can be detachably coupled to the hand crank (20) without tools,
b. the hand crank (20) is designed to be inserted into a through-bore in a drive shaft (15) of the coffee grinder (1),
c. the housing (2) is designed to be held in a user's hand during a grinding operation, the user being able to actuate the hand crank (20) with their other hand.

18. The coffee grinder system as claimed in claim 1, wherein the housing (2) is tubular or the housing (2) has a circular outer contour and/or a circular inner contour in a cross-sectional plane perpendicular to its direction of longitudinal extent.

19. The coffee grinder system as claimed in claim 1, wherein the housing (2) has a filling opening (18) for coffee beans that are to be ground.

20. The coffee grinder system as claimed in claim 1, wherein the housing (2) surrounds a receiving space for coffee beans that are to be ground.
